(19) United States
(12) Patent Application Publication
(10) Pub. No.: US 2010/0033501 A1
(43) Pub. Date: Feb. 11, 2010

(54) Method of image manipulation to fade between two images

(75) Inventors: Andrew Beaumont Whitesell, Honolulu, HI (US); Greg Raymond Ofiesh, Honolulu, HI (US)

Correspondence Address: STI MEDICAL SYSTEMS, LLC;IP MANAGER , SCIENCE & TECHNOLOGY INTERNATIONAL, 733 Bishop Street, Suite 3100, Honolulu, HI, 96813, US

(73) Assignee: STI Medical Systems, LLC

(21) Appl. No.: 12/228,298

(22) Filed: Aug. 11, 2008

(51) Int. Cl. G09G 5/00

(52) U.S. Cl. 345/634

(57) ABSTRACT

A process to fade between two frames of a dual frame digital TIFF image of an organ taken during an examination with a colposcope to use in computer-aided-diagnosis (CAD) systems.

### TECHNICAL FIELD

This invention generally relates to medical imaging and, more specifically to, a method of fading between an image with glint and an image without glint for diagnostic purposes. The method can be used to achieve high-quality standardized digital imagery to use in archive-quality medical records and Computer-Aided-Diagnosis (CAD) systems.

### BACKGROUND ART

Although this invention is being disclosed in connection with cervical cancer, it is applicable to many other areas of medicine. Uterine cervical cancer is the second most common cancer in women worldwide, with nearly 500,000 new cases and over 270,000 deaths annually (LARC, “Globocan 2002 database, “International agency for research in cancer, 2002, incorporated herein by reference). Colposcopy is a diagnostic method used to detect cancer precursors and cancer of the uterine cervix (B. S. Apgar, Brotzman, G. L. and Spitzer, M., Colposcopy: Principles and Practice, W. B. Saunders Company: Philadelphia, 2002, incorporated herein by reference). Using a colposcope, a clinician is able to take digital images of the cervix for closer examination. However, these images can often be impaired by glint (specular reflection), a perfect, mirror-like reflection of light from the tissue's surface, in which light from a single incoming direction (a ray) is reflected in a single outgoing direction. Glint contains no color information about the tissue surface from which it is reflected, in the same way that a mirror's image contains no color information about the mirror itself. The prior art teaches that glint is undesirable because it can mask features in an image that are important for detecting cancerous lesions by replacing color information in the affected pixels with information about the light source illuminating the tissue. In this way, glint both obstructs cancerous lesions from the view of the clinician, and introduces unwanted artifacts for automatic image feature-extraction algorithms.

Current technology is able to eliminate much of the glint in an image. However, in doing so, it not only eliminates specular reflection (glint) but also eliminates much of the valuable non-specular surface reflection of the tissue. In performing colposcopy. by altering the clinician's viewing angle of the tissue, for example by moving the clinician's head back and forth slightly, the clinician can utilize the variation of the surface reflection pattern to discern the three-dimensional structure of the tissue, as well as its surface texture. In image processing, it may not be possible or practical to use or obtain a view from a different angle. The three-dimensional structure of the tissue or organ and its surface texture are additional diagnostic information (beyond the information in the glint-free image) that aid the clinician in the detection of cancerous lesions. However, the prior art of which the inventors are aware discloses only alternating, side by side, comparing, or superimposing (composite or overlaying) of original and enhanced images.

The following patents and patent applications may be considered relevant to the field of the invention:

U.S. Pat. No. 7,313,261 to Dehmeshki et al., incorporated herein by reference, discloses a computer-implemented method of displaying a computed tomography (CT) scan image wherein an enhanced image is created by filtering an original image. The original and enhanced images can be displayed side by side or alternately, by switching one or more enhancement parameters on or off, to facilitate a comparison of the original and enhanced images.

U.S. Pat. No. 6,027,446 to Pathak, et al., incorporated herein by reference, discloses a method for determining pubic arch interference relative to the prostate gland of a patient using an ultrasound machine, where an initial image of the pubic arch and the prostate are taken, processed and then merged with each other to determine interference between the pubic arch and the prostate gland. Merging can be done by placing the two images together on the screen, one over the other (overlaid), or by automatic comparison of the two images (simultaneously displayed) to determine extent of overlap.

U.S. Pat. No. 7,259,731 to Allen, et al., incorporated herein by reference, discloses a method of overlaying at least a part of one or more medical images having one or more landmarks, wherein an image transmission device transmits images taken in a light reflecting structure and a medical overlay device overlays one or more images.

U.S. Pat. No. 6,901,277 to Kaufman, et al., incorporated herein by reference, discloses a method for viewing and generating a lung report. A baseline CT or MRI scan is analyzed to localize lung nodules, providing information so follow-up scans can easily locate lung nodules in the future. The original scan can be superimposed on the follow-up CT or MRI scan to create a composite image showing any change in the lung nodules.

U.S. Pat. No. 5,740,267 to Echerer, et al., incorporated herein by reference, discloses a method for analyzing a radiograph, such as an x-ray, wherein a user can zoom in on a desired portion of the radiograph and mark the image with landmarks or lines of interest between landmarks for analysis of the relationships between the landmarks and lines. The enhancements are stored separately from the unmodified image of the radiograph (which remains unmodifiable) so that a large amount of space required for storage of an enhanced image is avoided.

U.S. Pat. No. 6,993,167 to Skladnev, et al., incorporated herein by reference, discloses a system for collecting, storing and displaying dermatological images for the purpose of monitoring skin conditions. A hand-held unit illuminates the patient's skin, and an imaging device generates an image that can be stored for long periods of time so a physician can do a manual comparison or automatically by displaying the two images simultaneously. A calibration system corrects image data taken on any of multiple machines built to the same specification to a common reference standard to ensure absolute accuracy in color rendition.

U.S. Patent Publication No. 2007/0238954 to White, et al., incorporated herein by reference, discloses a method of creating an enhanced medical image wherein a reference image is taken of a subject (for example, by ultrasound) and then a second image is taken of the subject after a contrast agent is administered. Each image can be selected and compared by an operator to identify which tissue volumes have undergone contrast enhancement via contrast overly image.

U.S. Patent Publication No. 2006/0146377 to Marshall, et al., incorporated herein by reference, discloses an apparatus for scanning a moving object wherein the apparatus has a sensor oriented to collect a series of images of the object as it passes through a sensor field of view. An image processor estimates motion between two images taken from likelihood weighted pixels. It then generates a composite image from frames position according to respective estimates of object image motion.

U.S. Patent Publication No. 2008/0058593 to Gu, et al., incorporated herein by reference, discloses a process for providing computer aided diagnosis from video data of an organ during an examination with an endoscope, comprising analyzing and enhancing image frames from the video and detecting and diagnosing any lesions in the image frames in real time during the examination. Optionally, the image data can be used to create a 3 dimensional reconstruction of the organ.

U.S. Patent Publication No. 2008/0152204 to Huo, et al., incorporated herein by reference, discloses a method of processing a digital radiographic medical image wherein a region of interest (ROI) disease is identified from the image of tissue by a computer detection algorithm, a processing method appropriate to the identified ROI disease is determined and applied to the image to generate a disease enhanced ROI, resulting in a digital radiographic medical image with one or more disease enhanced ROIs.

### DISCLOSURE OF THE INVENTION

The present invention provides a method to fade between two digital images (preferably in the TIFF format). This method allows a user to fade glint in and out of an image to view an organ of interest as it actually appears (image with glint) and then fade to how it ideally appears (glint-free image). Tagged Image File Format (abbreviated TIFF) is a file format for storing images, including photographs.

This invention newly recognizes that it is desirable to provide the clinician with information from both the image with glint and the glint-free image, and to develop a method for easily fading between the two, to desired degrees. Thus, the present invention of a method of controlling the fading between an image with glint and a glint-free image is quite advantageous to cancer detection because it maintains the relationship between the image with glint and the glint-free image, meaning that the clinician is enabled to detect important features that may be masked by glint, and (by varying fading) it permits the three-dimensional shape and surface texture information in the image with glint to also be discerned. The ability to maintain the glint in an image to a user-selected extent to aid in the diagnosis of cancer provides unexpectedly and unpredictably better results over the prior art (which teaches that glint is undesirable). Another way to describe the invention is a method by which one can adjust the comparative opacity or transparency of the contributions of the two images to the final (combined) images.

The presently preferred embodiment of the invention includes a systematic framework of algorithms that fade, to a user-controllable extent, between two images of an organ (for example, the cervix) to produce a final (combined) image. One image depicts how the cervix actually appears (an image with glint), and the other image depicts how the cervix should ideally appear (a glint-free image). The user-controllable fading process allows for a comparison between the two images with different levels of fading (different levels of opacity or transparency) because, for example, different regions of the images may have different amounts of glint. This process maintains the relationship between the two images, and provides the clinician with unique final (combined) images for tissue examination. The process is useful to aid the clinician in the diagnosis of cancers, such as cervical cancer.

The presently preferred embodiment of the invention can also be used in conjunction with image pre-processing. Image pre-processing can include, for example, color enhancement, registration (alignment at all relevant points), filtering by morphological (shape) attributes, segmentation, and any other image pre-processing techniques now known or hereafter invented. Pre-processing can be applied before or after the fading algorithm.

### BRIEF DESCRIPTION OF THE DRAWINGS

FIG. 1 is a conceptual drawing illustrating registration and controlling opacity (or transparency) of images.

FIG. 2(a), FIG. 2(b), FIG. 2(c), and FIG. 2(d) are conceptual drawings illustrating user control of fading.

### BEST MODE FOR CARRYING OUT THE INVENTION

### 1. System Framework

The presently preferred embodiment of the invention discloses a process for fading between (adjusting the comparative opacity or transparency) two digital images of tissue or an organ (such as the cervix) obtained during an examination with a digital imager (such as a colposcope) in order to provide the user with a means to choose to combine an actual image (image with glint) with a glint-free image, to a user-controllable extent, to aid in the diagnosis of cancer.

First, an image with glint (such as an unpolarized, parallel-polarized, or singly-polarized image) and a glint-free image (such as a cross-polarized image) are obtained (collected) using a digital imager. Cross-polarized (XP) is when a first polarization orientation is perpendicular to a second polarization orientation. Parallel-polarized (PP) is where a first polarization orientation is parallel to the second polarization orientation. PP can also mean singly-polarized where there is only one polarization orientation, or can mean unpolarized.

The present invention preferably uses RGB (Red-Green-Blue) color space images of tissue or an organ taken with a digital imager, such as a digital colposcope. Color can be expressed as combinations of components colors, such as red, green, and blue, on a three-dimensional graph, to define a “color space”. The digital colposcope preferably collects both an image with glint (PP image) and the glint-free image (XP image). It eliminates (or suppresses) the glint in the latter image through cross-polarization. The images are then co-registered (aligned).

Next, a fade factor is calculated by the image fading algorithm for both the image with glint and the glint-free image, based on the proportion of either image the user wants to contribute to the final image (combined image). For example, the user could reduce the proportion of the glint-free image in the combined image by 20%. Once the fade factor is determined, the image fading algorithm combines the color channel values of both the image with glint and the glint-free image to produce the combined image. A color channel value, for example, is an integer between 0 and 255 (if 2⁸=256 bits of information are used to measure intensity or brightness) assigned to each of the three color channels in each pixel of a color image (an image taken in a color space), such as an RGB (the red, blue and green) image. For example, the greater the glint-free image's fade factor, the less the glint-free image's color channel value contributes to the final color channel value in the combined image. Thus, the combined image will appear less similar to the glint-free image (rather than the image with glint) as the glint-free image's fade factor increases.

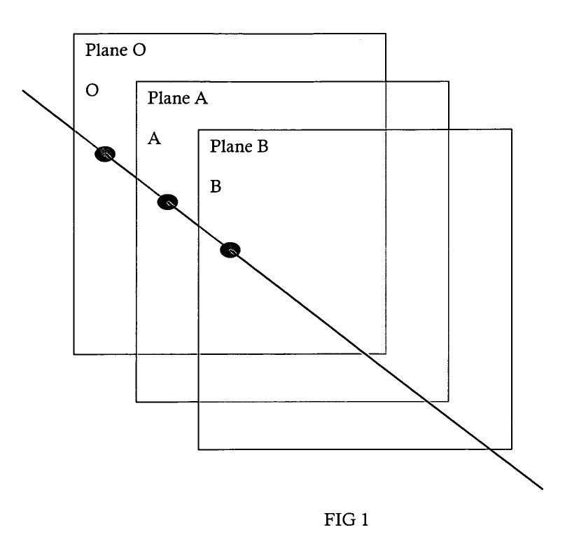

FIG. 1 depicts how, for example, three images, plane O, plane A, and plane B, are co-registered, and how the same pixel in each image is related to other pixels. Plane O does not have any correction performed on its pixel values. The term “correction” refers to the adjustment of the pixel values to adjust the opacity or transparency of the image. Plane A is corrected relative to plane O, that is, when the user adjusts plane A, or corrects it, he or she is making it appear transparent to plane O. Technically, this means the pixel values of both are adjusted to give the appearance that plane A is corrected or adjusted in its opacity, while plane O remains 100% opaque. Then, applying the result of plane O merged with plane A, the algorithm performs the same process of correcting Plane B against the intermediate result of plane O merged with plane A. Black can be transparent—the black RGB value of (0, 0, 0) can be interpreted as transparent. When the planes are co-registered (aligned), the points O, A, and B are on top of each other. They are the same coordinates, but on different planes.

### 2. Image Fading Algorithm

The image fading algorithm is preferably comprised of two processes. The first process preferably calculates the fade factor (or fade value) of the image with glint and the glint-free image. The fade factor is calculated based on the user's preference and inputted via a slider control or similar device.

The second process preferably takes the fade factor and uses it to combine the color channel values of the image with glint and the glint-free image to create the combined image. For example, if a user wants 80% of the glint-free image in the combined image, this algorithm will calculate the fade factor for both the image with glint and the glint-free image, combine them together, and produce an image that is comprised of 80% of the glint-free image and 20% of the image with glint.

The algorithm takes the pixel value from the first image and adjusts it against a scale based upon the fade factor. It then takes the corresponding pixel value from the second image and adjusts it against the same scale, but from the opposite end. As the fade factor changes, one pixel's value is adjusted from the low end to the high end of the fade scale, while the other value is adjusted from the high end to the low end of the same fade scale. The two values are then combined using addition. See FIG. 1.

The final color channel value of the combined image is preferably calculated using computer software which utilizes the following computer code:

FadeArray2=FadeArray[Pane2FadeFactor]

FadeArray1=FadeArray[MAX−Pane2FadeFactor]

FinalChValue=FadeArray2[Pane2ChValue]+FadeArray1[Pane1ChValue]

Another way of looking at this is described here:

FinalChValue=Pane2ChValue*Pane2FadeFactor/MAX+Pane1ChValue*(MAX−Pane2FadeFactor )/MAX

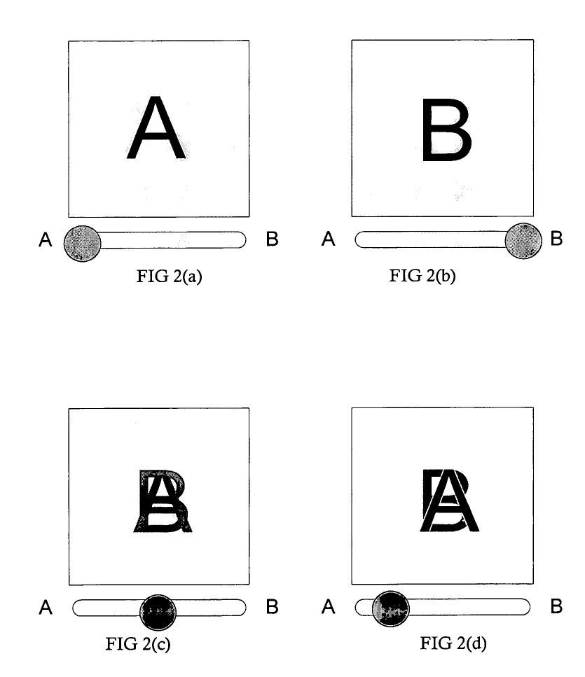

The entire fading process described above is equivalent to co-registering a first image (with glint) and a second image (without glint) and either decreasing the opacity or increasing the transparency of the first image as it sits in front of the second image, while the opacity or transparency of the second image remains the same. Alternatively, the position of the first image could be behind the second image, and the second image's opacity could be decreased or its transparency increased. This alternative is shown in FIG. 2(a) through FIG. 2(d).

For example, FIG. 2(a), FIG. 2(b), FIG. 2(c), and FIG. 2(d) each show an image of the letters A and B. In FIG. 2(a), the letter A is 100% opaque and the letter B is 0% opaque (or 100% transparent). The slider (under the box) is completely to the left, indicating the opacity scale is completely biased towards image A. In FIG. 2(b), the letter A is 0% opaque (or 100% transparent) and the letter B is 100% opaque. The slider is completely to the right, indicating the opacity scale is completely biased towards image B. In FIG. 2(c), the letter A is 50% opaque and the letter B is 50% opaque and, the slider is in the middle of the slider bar, indicating that both images are of equal opacity. Lastly, in FIG. 2(d), the letter A is 80% opaque and the letter B is 20% opaque. The slider is positioned ⅕ the length of the slider bar towards A, indicating that image A is 20% transparent (80% opaque) and image B is 80% transparent (20% opaque).

### 3. Image Pre-Processing

The present invention may also be used with image pre-processing before or after the fading technique is applied. Pre-processing may include, for example, color enhancement, registration (alignment), filtering by morphological attributes, segmentation, or any other image pre-processing technique now known or hereafter invented. Image pre-processing is advantageous because, for example, changes in tissue may occur rapidly during the time during which tissue is being monitored, and these pre-processing techniques make it easier to compare chronologically separated images. For example, when an area of an organ is treated during acetowhitening (a method to identify tissue that changes color after acetic acid application), tissue that is not potentially cancerous may also change color (in addition to the suspected cancerous region). Image pre-processing, would allow, through color or morphological analysis, analysis and exclusion of non-suspect tissue, such as a blood vessels, from a digital image. By way of another example, because the tissue being analyzed will often move during the course of an evaluation with a colposcope, relevant regions of digital images taken during an evaluation must be registered (aligned) to compensate for this movement before the fading algorithm can be used. Otherwise, a viewer may be fading between two images that are not of exactly the same tissue regions. Region detection pre-processing can be help in this respect by quickly identifying the same tissue regions in two chronologically separated images. Thus, the pre-processing technique can register the two images so the fading algorithm can be applied to the same tissue regions.

### INDUSTRIAL APPLICABILITY

The present invention provides a method for fading between two images for diagnostic purposes and may also be suitable for diagnosing other types of cancers, such as colorectal cancer and skin cancer, or in evaluating any other pairs of images that differ in glint or some other property. The process may also be combined with other instruments and methods that automatically analyze and adjust the quality of acquired images.

What is claimed is:

1. A method of fading between two digital images of an organ comprising:
obtaining an image with glint and a glint-free image, wherein said images contain pixels having color channels, each of said color channels containing color channel values;
co-registering said image with glint and said glint-free image; and
fading between said image with glint and said glint-free image to produce a combined image that maintains the relationship between said image with glint and said glint-free image;
whereby additional diagnostic information, beyond information in said glint-free image, that aids in the detection of cancerous lesions is provided.

2. A method according to claim 1, wherein said fading step comprises applying a fading algorithm to calculate a fade factor for said image with glint and said glint-free image and combines said color channel values of said image with glint and said glint-free image using said fade factors to produce said combined image.

3. A method of fading between two digital images of an organ comprising:
obtaining an image with glint and a glint-free image, wherein said images contain pixels having color channels, each of said color channels containing color channel values;
co-registering said image with glint and said glint-free image; and
applying a fading algorithm to calculate a fade factor for said image with glint and said glint-free image, and combining said color channel values of said image with glint and said glint-free image using said fade factors to produce a combined image that maintains the relationship between said image with glint and said glint-free image;
whereby additional diagnostic information, beyond information in said glint-free image, that aids in the detection of cancerous lesions is provided.

4. A method of fading between two digital images comprising:
obtaining a first image and a second image of an organ;
co-registering said first image and said second image, wherein said first image is placed in front of said second image;
controllably decreasing opacity of said first image; and
whereby additional diagnostic information, beyond information in said first image, is provided.

5. A method of fading between two digital images comprising:
obtaining a first image and a second image of an organ;
co-registering said first image and said second image, wherein said first image is placed in front of said second image;
controllably increasing transparency of said first image; and
whereby additional diagnostic information, beyond information in said first image, is provided.

6. A method of fading between two digital images comprising:
obtaining a first image and a second image of an organ;
co-registering said first image and said second image, wherein said first image is placed in front of said second image;
controllably fading said first image; and
whereby additional diagnostic information, beyond information in said first image, is provided.

7. A method according to anyone of claims 4, 5, or 6 wherein said first image is an image with glint and said second image is a glint-free image.

8. A method according to anyone of claims 4, 5, or 6 wherein said first image is an glint-free image and said second image is an image with glint.
